(19) United States
(12) Patent Application Publication
(10) Pub. No.: US 2026/0216959 A1
(43) Pub. Date: Jul. 30, 2026

(54) Devices and Methods for Post-Processing Additive-Manufactured Workpieces

(71) Applicant: Solventum Intellectual Properties Company, Maplewood, MN (US)

(72) Inventors: Joachim W. Zech, Kaufering (DE); Hendrik M. Grupp, Seefeld (DE); Dietmar Blees, Loehne (DE); Ralf Schlimper, Melle (DE); Ralf M. Paehl, Melle (DE); Malte Korten, Moorenweis (DE)

(21) Appl. No.: 19/144,136

(22) PCT Filed: Dec. 19, 2023
(86) PCT No.: PCT/IB2023/062959

§ 371 Date: Jun. 27, 2025

Related U.S. Application Data
(60) Provisional application No. 63/477,687, filed on Dec. 29, 2022.

(51) Int. Cl. B29C 64/357; B29C 71/02; B33Y 40/20

(52) U.S. Cl. CPC B29C 64/357; B29C 71/02; B33Y 40/20

(57) ABSTRACT

Post-processing devices for post-processing additive-manufactured workpieces and methods thereof are described. Sequential cleaning and post-curing under vacuum may be accomplished within a single device. The post-processing device (100, 200A, 400) comprises: a chamber (102, 202, 402) comprising an inlet (104, 204, 404) configured to be in communication with a vacuum source, and an electrical outlet configured to be in communication with a power source; a spinning platform (108, 208, 308, 408) for retaining a plurality of workpieces (222), a rotating drive apparatus (118, 218, 418) for rotating the spinning platform; a collection vat (116, 216, 416) surrounding the spinning platform; and one or more post-curing light source (120, 220, 420); wherein the spinning platform, the rotating drive apparatus, and the collection vat, are housed within the chamber.

### BACKGROUND

Additive-manufacturing processes, such as stereolithography, allow for swift construction of a variety of workpieces. Workpieces produced in this manner often retain uncured excess build material on surfaces. While post-curing excess build material is acceptable for many workpieces produced in this manner, it is not desirable for workpieces that require precision, such as dental crowns or dental bonding trays. For workpieces requiring precision, excess build material is often removed by washing the workpiece with a solvent. However, some build materials, such as long-chain polymers described herein, are not suitable for washing since common solvents can cause the material to swell and potentially crack when cured under vacuum due to permeated solvents. In addition, washing workpieces with solvent often provides a matte surface. It is preferred that dental articles maintain a glossy surface for appearance and optical properties, such as light transmission.

What is needed are post-processing devices and processes for cleaning and post-curing workpieces requiring high precision and glossy surfaces in a timely and environmentally friendly manner.

### SUMMARY

In one embodiment, a post-processing device is described. The post-processing device includes a chamber having an inlet configured to be in communication with a vacuum source and an electrical outlet configured to be in communication with a power source. The post-processing device further includes a spinning platform for retaining a plurality of workpieces, a rotating drive apparatus for rotating the spinning platform, a collection vat surrounding the spinning platform, and one or more post-curing light source. The spinning platform, the rotating drive apparatus and the collection vat are housed within the chamber.

In one embodiment, a method for cleaning and post-curing a plurality of workpieces is described. The method includes providing a post-processing device described herein, spinning the plurality of workpieces on a spinning platform at a rate effective to remove at least a portion of excess build material from the plurality of workpieces, applying a vacuum to the chamber effective to reduce the pressure within the chamber, and applying a curing light to the plurality of workpieces while under vacuum for a period sufficient to cure the plurality of workpieces.

In one embodiment, a method for cleaning and post-curing a plurality of workpieces is described. The method includes spinning the plurality of workpieces on a spinning platform at a rate effective to remove at least a portion of excess build material from the plurality of workpieces, and applying a curing light to the plurality of workpieces while under vacuum for a period sufficient to cure the plurality of workpieces. The plurality of workpieces are characterized by a molecular weight of 1,000-20,000 and a viscosity of at least 6 Pa*s at 20 s⁻¹ at 23° C.

### BRIEF DESCRIPTION OF DRAWINGS

FIG. 1 is a cut-away illustration of an example post-processing device of the present disclosure.

FIG. 2A is a cut-away illustration of an example post-processing device of the present disclosure, including a plurality of workpieces.

FIG. 2B is an enlarged illustration of the post-processing device of FIG. 2A.

FIG. 3 is an illustration of an exploded spinning platform assembly.

FIG. 4 is a cut-away illustration of an example post-processing device of the present disclosure.

### DETAILED DESCRIPTION

The present disclosure is directed toward post-processing devices and methods of use thereof for cleaning and post-curing workpieces that are produced by additive-manufacturing processes. The post-processing devices of the present disclosure are especially useful for cleaning workpieces that are otherwise difficult or currently impossible to adequately clean, such as workpieces comprised of long-chain polymers described herein. Surprisingly, it was discovered that long-chain polymers of the present disclosure were easily spin-cleaned, despite their high viscosity.

In addition, the post-processing devices and methods can be tailored to the type of workpiece and to the properties of the build material thereof. Cumbersome post-processing steps are consolidated with the post-processing devices of the present disclosure in that both cleaning and post-curing, especially post-curing under reduced pressure, can be done within a single unit. Furthermore, post-processing devices of the present disclosure not only avoid use of hazardous and/or wasteful chemical cleaners (e.g., solvents) and gases (for post-curing), but also allow for recovery and/or recycling of excess build material.

The numerical identifiers of the features within the figure descriptions below are conserved, e.g., spinning platform 108 is akin to spinning platforms 208, 308, 408, and the like.

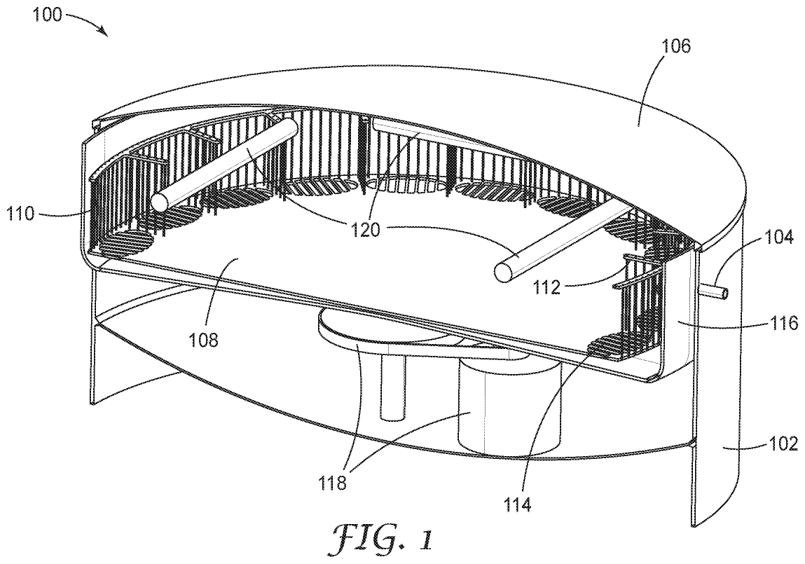

FIG. 1 depicts a cut-away illustration of a post-processing device 100. Post-processing device 100 includes a chamber 102 having an inlet 104 configured to be in communication with a vacuum source, and a lid 106. While not shown, post-processing device 100 also includes an electrical outlet configured to be in communication with a power source. Post-process device 100 further includes a spinning platform 108 for retaining a plurality of workpieces. Spinning platform 108 is shown having a retention feature 110 in the form of a retention wall with partitioned units 112, wherein each of the retention wall and partitioned units are shown having grated features. Spinning platform 108 is also depicted having grated features 114 thereon. Post-processing device 100 is further shown having a collection vat 116 surrounding spinning platform 108. Below spinning platform 108 and collection vat 116 is a rotary drive apparatus 118 for spinning one or more of spinning platform 108 and collection vat 116. Light sources 120 are positioned above spinning platform 108 for post-curing workpieces (not shown).

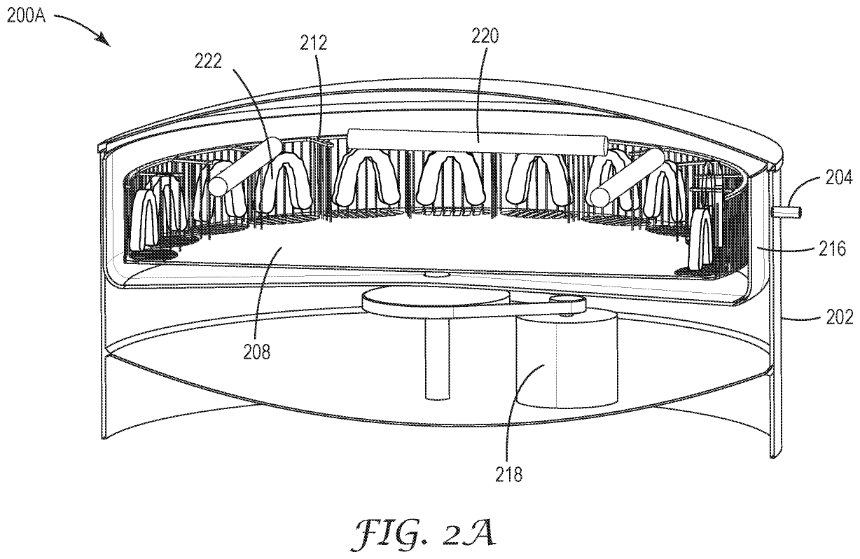

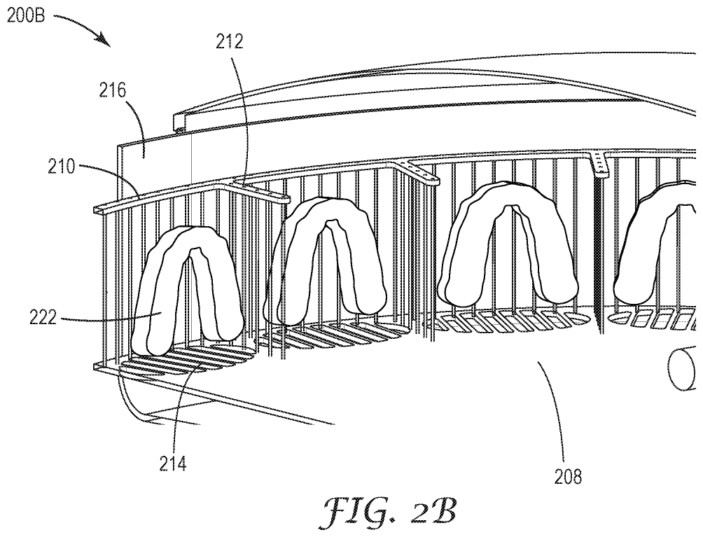

FIG. 2A depicts a cut-away illustration of a post-processing device 200A with workpieces 222 shown within partitioned units 212. Post-processing device 200A includes the features described in post-processing device 200, e.g., chamber 202, inlet 204, spinning platform 206, spinning platform 208, retention feature 210 in the form of a retention wall, partitioned units 212, collection vat 214, rotary drive apparatus 218, and light source 220.

FIG. 2B is a zoomed-in depiction 200B of post-processing device 200A. Workpieces 222 are retained on spinning platform 208 by way of a grated retention wall 210 and grated partitioned units 212. The area of spinning platform 208 below workpieces 222 includes grated features 214. Collection vat 216 surrounds spinning platform 208.

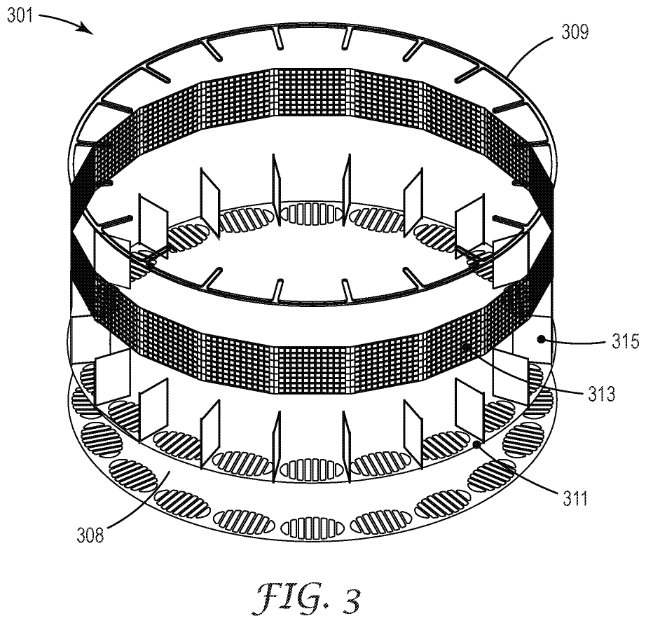

FIG. 3 depicts an exploded example spinning platform assembly 301 for use in a post-processing device of the present disclosure. Spinning platform assembly 301 includes a spinning platform liner 311 for overlaying a spinning platform 308. Spinning platform assembly 301 further includes a removable retention wall 313 and removable partition units 315. As shown, spinning platform 308 further includes a liner retainer 309 for securing spinning platform liner 311, removable retention wall 313 and removable partition units 315 to spinning platform 308.

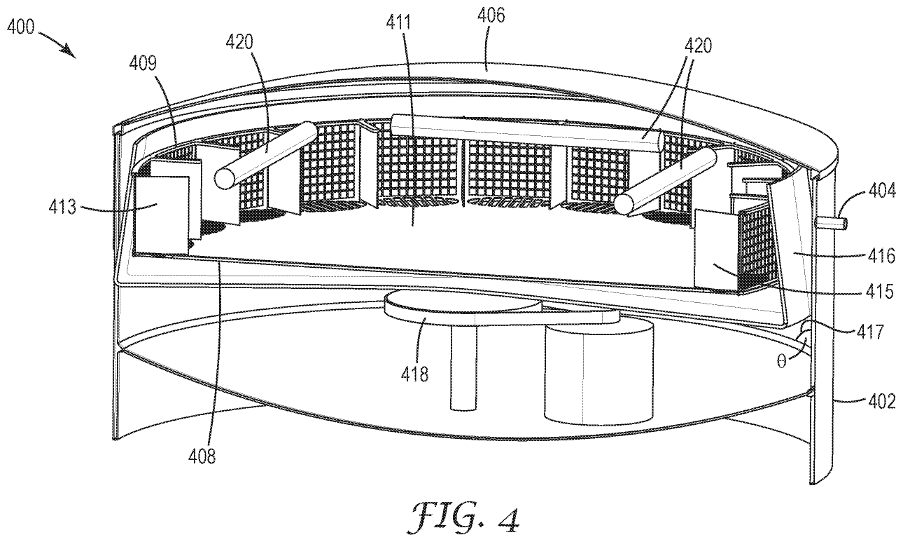

FIG. 4 depicts a cut-away illustration of a post-processing device 400. Post-processing device 400 includes many of the features described in preceding figures, e.g., chamber 402, inlet 404, lid 406, spinning platform 408, collection vat 416, rotary drive apparatus 418, and light sources 420. Post-processing device 400 includes collection vat 416 having inward-slanting walls at an angle θ (417). Post-processing device 400 is further shown having a spinning platform assembly including a removable retention wall 413 and removable partition units 415 and a liner retainer 409.

### Definitions

As used herein, “about” means±10 percent of a given value. For example, about 10 means 9 to 11.

As used herein, “additive-manufacturing” refers to a process of creating a three-dimensional object by building one layer at a time. Stereolithography is a type of additive-manufacturing that employs light for curing polymerizable resins. Data based on computer-aided design (CAD), or computer-aided manufacturing (CAM), is used to project a light pattern onto a polymerizable resin, thereby curing the polymerizable resin to produce a workpiece of a desired shape.

As used herein, “build material” refers to the material used to construct a workpiece. Build materials are typically include a selection of light-curable monomers, i.e., monomers that undergo polymerization (i.e., curing) in the presence of certain wavelengths of light.

As used herein, “centrifugal force” refers to an outward force, away from the axis of rotation, acting on a revolving object. “Centrifugal cleaning” refers to removal of a substance via centrifugal force.

As used herein, “chamber” refers to an object with an enclosed space.

As used herein, “cleaning” refers to the removal of a material from a workpiece (e.g., excess build material).

As used herein, “dental article” means any article which is to be used in a dental or orthodontic field, e.g., dental restorations, tooth models, orthodontic devices, or the like.

As used herein, “excess build material” refers to a material used to construct a workpiece that remains on the workpiece in excess. Excess build material is uncured or semi-cured material that is not desired in the final article.

As used herein, “grated features” refers to an arrangement of substance with lack of substance. Grated features may be patterned or not patterned. For example, a grated feature may be a plurality of rods extending across a hole, holes or slotted holes of any shape within a substance, a chain-link or cross-hatched arrangement of substance, or the like.

As used herein, “long-chain polymer” refers to polymers characterized by a molecular weight from about 1,000-20,000 and a viscosity of at least about 6 Pa*s at 20 s⁻¹ at 23° C.

As used herein, the phrase “one or more of” such as used in the phrase “one or more of A and B” or “one or more of at least one A and at least one B” means a composition may include at least one A, more than one A, at least one B, more than one B, at least one A and at least one B, more than one A and more than one B. In other words, the phrase is not intended to mean the composition must have at least one of each of A and B.

As used herein, “partition unit” or “partitioned unit” refers to a vertical wall relative to the plane of spinning platform that at least partly partitions one area from another.

As used herein, “post-curing” refers to a final curing process. Post-curing does not involve the initial curing during construction of the workpiece. Post-curing can be accomplished via light curing, thermal curing, or both, depending on the type of build material. he post-processing devices of the present disclosure are equipped to handle photocurable post-processing an optionally thermal post-processing.

As used herein, “polycarbonate (meth)acrylate” refers to a polymer having more than one moiety of the following: —OC(O)O—; and at least one moiety of the following: —OC(O)C(R)=CH₂, wherein R is —H or —CH₃.

As used herein, “polyester (meth)acrylate” refers to a polymer having at least one moiety of the following: —OC(O)—C₂₋₁₀ alkylene-C(O)O—; and at least one moiety of the following: —OC(O)C(R)=CH₂, wherein R is —H or —CH₃.

As used herein, “polyether (meth)acrylate” refers to a polymer having more than one moiety of the following: —(O—C₂₋₁₀ alkylene)ₙ-; and at least one moiety of the following: —OC(O)C(R)=CH₂, wherein R is —H or —CH₃.

As used herein, “post-processing” refers to actions upon a workpiece following construction of said workpiece, e.g., cleaning, post-curing, and the like. “Post-processing devices” refer to devices that allow for actions upon a workpiece following construction of said workpiece.

As used herein, “retention wall” refers to a vertical wall relative to the plane of the spinning platform that is positioned perpendicular to a centrifugal force vector.

As used herein, “viscosity” described herein is measured using a ThermoHaake Rotovisco 1 device with a plate/plate system (diameter 20 mm) and a slit of 0.2 mm. The viscosity values can be recorded for each share rate (e.g., 10 l/s to 100 l/s in 10 l/s steps). For each share rate, a delay of 5 seconds can be used before collecting data. This method of measurement corresponds to DIN 53018-1.

As used herein, “workpiece” refers to an article that has been produced (i.e., built) by an additive-manufacturing technique.

### Post-Processing Devices

In various embodiments, a post-processing device is described. The post-processing device may include a chamber having an inlet configured to be in communication with a vacuum source and an electrical outlet configured to be in communication with a power source. The post-processing device may further include a spinning platform for retaining a plurality of workpieces, a rotating drive apparatus for rotating the spinning platform, a collection vat surrounding the spinning platform, and one or more post-curing light source. The spinning platform, the rotating drive apparatus and the collection vat may be housed within the chamber.

In some embodiments, the post-processing device may further include replaceable liners for any of the components therein. For example, the post-processing device may include one or more of a spinning platform liner, a collection vat liner, a chamber wall liner, a light source liner, or the like. Replaceable liners may serve for easy cleaning in that they may be removed from the post-processing device along with any excess build material thereon. Replaceable liners may include material comprised of silicone, woven or nonwoven fabric, paper, wax, or a combination thereof. Replaceable liners may be absorbent, adsorbent, or otherwise inert toward the build material. In some embodiments, liners may be reusable (i.e., cleanable). In other embodiments, the liners may be disposable.

In some embodiments, the post-processing device may further include a holding reservoir for housing excess build material that is removed from the workpiece during the cleaning process. In some embodiments, the holding reservoir is beneath the collection vat.

In some embodiments, the post-processing device may further include a heating element. A heating element may serve to soften, or otherwise reduce the viscosity of the excess build material that is removed from the workpiece. Softening of the excess build material may allow for easier migration of the excess build material into one or more of the collection vat and a housing reservoir.

In some embodiments, the post-processing device may further include a controller to control process steps and parameters.

In some embodiments the post-processing device may be configured to accommodate workpieces that are dental articles. In some embodiments, the workpiece may be selected from a crown, an implant, a bridge, a cap, a denture, an inlay, an onlay, a veneer, a facing, a coping, an abutment, a bracket, a buccal tube, a cleat, an attachment, a button, an aligner, a retainer, an indirect bonding tray, and a direct bonding tray. In some embodiments, the workpiece may be an indirect bonding tray or a direct bonding tray. In some embodiments, the post-processing device may be adjustable to accommodate any workpiece. For example, a post-processing device may be modular in the sense that it may accommodate different retention features, e.g., based on size, shape, or the like.

In many embodiments, features of the post-processing device described below may be present in the device alone or in combination with any of the features of the post-processing device described.

### Chamber

In many embodiments, features of the chamber described below may be present or in combination with any of the features of the chamber described.

In some embodiments, the chamber may be in the shape of a cylinder, a cone, a sphere, an ellipsoid, a cube, a cuboid, or any approximate shape thereof. In some embodiments, the chamber may be characterized by a width of about 300 mm to about 650 mm and a length of about 300 mm to about 650 mm. For example, the chamber may be characterized by a width in mm of about 300, 320, 350, 380, 400, 420, 450, 480, 500, 520, 550, 580, 600, 620, or 650, or a value between any of the preceding values, e.g., between about 350 and about 400, or the like; and a length of about 300, 320, 350, 380, 400, 420, 450, 480, 500, 520, 550, 580, 600, 620, or 650, or a value between any of the preceding values, e.g., between about 350 and about 400, or the like

In some embodiments, the chamber may have an outer wall and an inner wall (i.e., double-walled). The outer wall and the inner wall may be of the same or different shape. For example, the outer wall and the inner wall may both be cylindrical in shape. In some embodiments, the inner wall may be shorter in length than the length of the outer wall. For example, the length of the inner wall may be about 50%, 55%, 60%, 65%, 70%, 75%, 80%, 85%, 90%, or 95% or 99% of that of the length of the outer wall, or a range between any of the preceding values, e.g., between about 75% and about 90%, or the like. In some embodiments, the outer wall and the inner wall may form a chamber within a chamber. In some embodiments, space between the outer wall and the inner wall may be filled with a material (e.g., insulation) or simply air, or alternatively under vacuum.

In many embodiments, the chamber is constructed to withstand an internal pressure of less than about 15 kPa, i.e., under vacuum. In some embodiments, the chamber may be constructed of materials selected from steel, aluminum, brass, high density ceramic, glass, acrylic, or a combination thereof.

In some embodiments, the inlet configured to be in communication with a vacuum source can be located anywhere within the chamber. However, the inlet is ideally located in an area that is not in-line with the centrifugal force vector. For example, the inlet may be located above or below the spinning platform.

In some embodiments, the chamber may further include a lid positioned above the spinning platform. The lid may be configured to allow for easy removal of one or more components within the chamber. In some embodiments, one or more components (e.g., spinning platform, collection vat, features thereof, or the like) may be replaceable, cleanable outside of the chamber, or otherwise include a removable cover thereon. In many embodiments, the lid may be equipped with a means to provide a vacuum-seal. In other words, the lid may mate with the chamber such that an internal chamber pressure may be applied, e.g., via use of a gasket.

In some embodiments, the chamber may further include an additional means to access one or more components within the chamber. A chamber may include a side door, for example, for easy removal of a housing reservoir used to store excess build resin that is removed from workpieces. A side door would need to be configured to withstand reduced pressure within the chamber.

### Spinning Platform

In many embodiments, features of the spinning platform described below may be present alone or in combination with any of the features of the spinning platform described.

In some embodiments, the spinning platform may be configured to be in any shape, e.g., a circle, an oval, a square, a rectangle, or the like.

In some embodiments, the spinning platform may be in the shape of a circle and characterized by a diameter of about 150 mm to about 400 mm. For example, the spinning platform may be characterized by a diameter of 150, 180, 200, 220, 250, 280, 300, 320, 350, 380, or 400, or a value within a range between any of the preceding values, e.g., between about 200 and about 250, or the like.

In some embodiments, the spinning platform or any features thereof may be comprised of a transparent material. A transparent material may allow post-curing light to be transmitted through the material to cure workpieces.

In some embodiments, the spinning platform may be solid or include grated features. A spinning platform with grated features may allow for excess build material to pass through the spinning platform into the collection vat. In some embodiments, the spinning platform may include grated features in select areas, e.g., beneath each of the positioned workpieces.

In some embodiments, the spinning platform may further include one or more retention feature for securing each of the plurality of workpieces to the spinning platform. For example, a retention feature may include a clip, a hole or slot for receiving a build brim, a retention wall, a partition unit, or the like. In some embodiments, one or more retention features may also be configured to reorient the workpiece. For example, one or more retention feature may be mechanically reoriented such that the direction changes in which the retained workpiece faces. Excess build material is more readily removed from a workpiece surface that is aligned with the centrifugal force (i.e., the surface facing away from the center of the spinning platform experiences better cleaning upon spinning). In some embodiments, reversing the spin direction of the spinning platform may mechanically reorient the one or more retention feature. Otherwise, one may manually or electronically reorient the one or more retention feature.

In many embodiments, the spinning platform may further include a retention wall. A retention wall may prevent workpieces from being ejected from the spinning platform upon spinning. For example, a retention wall may simply be a vertical wall that surrounds the spinning platform. In some embodiments, the retention wall may include grated features to allow for passage of excess build material through the retention wall and into the collection vat. For example, the grated features may be in any pattern, e.g., slotted, chain-linked, cross-hatched, or the like.

In some embodiments, the spinning platform may include a plurality of partitioned units wherein each partitioned unit may be configured to retain a single workpiece. In many embodiments, at least a portion of any partitioned unit may include a segment of a retention wall. For example, partitioned units may include areas that are at least partly enclosed, or fully enclosed, by way of partition walls that separate partitioned units along the retention wall. Said partition walls may be solid, or alternatively, include grated features to allow for passage of excess build material. In some embodiments, partition walls may be situated at an angle relative to a centrifugal force vector when the spinning platform is spinning. In some embodiments, partition walls situated at an angle relative to a centrifugal force vector may aid movement of any excess build material in contact with the partitioned walls toward the collection vat when the spinning platform is spinning. The angle in which the partition walls may be situated, relative to a centrifugal force vector. may be about 0° to about 45°. For example, the angle in which the partition walls may be situated at an angle (°) relative to a centrifugal force vector of about 0 (i.e., parallel to vector), 2, 5, 8, 10, 12, 15, 18, 20, 22, 25, 28, 30, 32, 35, 38, 40, 42, or 45, or a value within a range between any of the preceding values, e.g., about 5 to about 20.

In some embodiments, a retention wall, along with any partitioned walls thereof, may be attached to the spinning platform in a permanent manner, or alternatively, in a removable manner. Likewise, any partitioned walls may be attached to a retention wall in a permanent manner, or alternatively, in a removable manner. For example, a spinning platform assembly may include a spinning platform with one or more removable features, such a removable spinning platform liner configured to overlay the spinning platform, a removable retention wall, and/or removable partition units. Removable retentions walls and removable partition units may be assembled to a removable platform liner, or otherwise permanently attached. Removable features may allow for easy cleaning or may be easily replaced. Such removable liners and features may be constructed from materials such as silicone, woven or nonwoven fabric, paper, wax, or a combination thereof.

In some embodiments, a retention wall, along with any partitioned walls thereof, may be adjustable in position and/or orientation along the spinning platform, e.g., the spinning platform may have means to secure a retention wall, along with any partitioned walls thereof, in different positions. For example, means to secure a retention wall may be holes, slots, slides, clips, or the like. The ability to reposition a retention wall can effectively change the amount of centrifugal force that will be exerted on a workpiece upon spinning, i.e., workpieces positioned closer to the center of the spinning platform would experience less centrifugal as opposed to workpieces positioned further from the center. The option to choose where a workpiece may be positioned along the spinning platform may allow users to adjust how much centrifugal force may be required to achieve desired cleaning. Likewise, a user may determine that too much centrifugal force may not be appropriate for certain materials within the workpiece, i.e., some materials may be prone to deformation upon experiencing too much centrifugal force and can be positioned closer to the center of the spinning platform, accordingly.

### Collection Vat

In many embodiments, features of the collection vat described below may be present alone or in combination with any of the features of the collection vat described.

In some embodiments, the collection vat may be composed of a material that is insufficient to adhere to a selected resin matrix. For example, the collection vat may be composed of a silicone.

In some embodiments, the collection may include a base that is shaped in any configuration, e.g., a circle, an oval, a square, a rectangle, or the like.

In many embodiments, the collection vat is configured to spin in a similar manner as the spinning platform. The collection vat may be spun in conjunction with the spinning platform, i.e., operated by the same rotating drive apparatus. Alternatively, the collection vat may be spun independent of the spinning platform, e.g., operated by a separate rotating drive apparatus. Either way, spinning of the collection vat may encourage movement of excess build material within the collection vat. Movement of excess build material may serve to consolidate the excess build material into a localized area for easy cleaning and/or may serve to move the excess build material into an area for drainage and recovery.

In some embodiments, the collection vat may be in the shape of a half cylinder that surrounds the spinning platform. Alternatively, the collection vat may be in the shape of a half (pseudo) cylinder having an inward-slanting wall. A collection vat having an inward-slanting wall may allow for excess material to migrate into the corner of the collection vat when under centrifugal force. In some embodiments, an inward-slanting wall may be characterized by an angle (θ) about 30° to about 85° relative to a plane encompassed by a base portion of the collection vat. For example, the wall may be slanted inward relative to normal of about 30, 35, 40, 45, 50, 55, 60, 65, 70, 75, 80, or 85, or a value within a range between any of the preceding values, e.g., between about 45 and about 65, or the like.

In some embodiments, the collection vat may include a gutter for collecting excess build material. A gutter may be characterized as area that is lower than the base of the collection vat. Gutters within the collection vat may allow for excess build material to flow into the gutter for easier removal from the collection vat. In some embodiments, a gutter may extend around the perimeter of the collection vat. In other embodiments, gutters may be localized in areas of the collection vat (e.g., in corners of a collection vat that is in a square configuration).

In some embodiments, a collection vat in the shape of a half cylinder (e.g., with inward-slanting walls) may have a base that only connects to the (e.g., inward-slanting) wall in select locations. A base that only connects to the collection vat wall in select locations may allow for excess build material to exit the collection vat through the areas in which the base is not connected to the walls. For embodiments having a holding reservoir beneath the collection vat, excess build material may flow into the holding reservoir by way of the areas in which the collection vat base and wall are not connected. One advantage of having a holding reservoir beneath the collection vat is that excess build material within the holding reservoir may be shielded from post-curing light so that it may be reused.

In other embodiments, a collection vat may be in the shape of a square or a rounded square. Under centrifugal force, excess build material may migrate to the corners of a collection vat in the shape of a square or rounded square for easy removal. In some embodiments, a collection vat in the shape of a square or a rounded square may further include areas (e.g., within the corners) in which the base is not connected to the wall. Excess build material may flow to such areas under centrifugal force (i.e., spinning collection vat) and exit the collection vat into a holding reservoir beneath the collection vat.

### Housing Reservoir

In some embodiments, a housing reservoir may be located beneath the collection vat in which excess build material collected in the collection vat during cleaning may subsequently migrate into the housing reservoir. Incorporating a housing reservoir may be advantageous for recovering excess build material for later use. Even if reuse of excess build material is not intended, a housing reservoir may significantly decrease efforts for cleaning the device since the excess build material can be consolidated in the housing reservoir. Furthermore, disposal of uncured excess build material, as an opposed to cured excess build material that has been exposed to post-cure light, may have less of an impact on the environment. A housing reservoir can effectively shield collected excess build material from post-cure light, whereas excess build material within a collection vat would most likely cure (i.e., polymerize) under subsequent post-cure processes.

In some embodiments, a housing reservoir may be conical in shape. A conical-shaped housing reservoir may serve to migrate (uncured) excess build material in a single location for easy recovery. That is, the sloped walls of a conical housing reservoir may allow for better flow of the excess build material into the tip of the housing reservoir. In other embodiments, a housing reservoir may be of any shape.

In some embodiments, a housing reservoir may be configured to be in communication with a vacuum source (and vacuum trap) to facilitate recovery of the uncured excess build material from within the post-processing device. A housing reservoir fitted with an inlet to be in communication with a vacuum source may further serve to reduce the pressure within the chamber in preparation for post-curing under vacuum.

### Heating Element

In some embodiments, a heating element may include a non-curing light source, components of an induction heater (e.g., electromagnet, electronic oscillator for passing high frequency alternating current), components of a convention heater, or a combination thereof. For example, a heating element may serve to increase the temperature throughout the chamber. Alternatively, a heating element may be directed toward, or within, select chamber components, e.g., the collection vat, the housing reservoir, or the like. A heated collection vat, for example, may reduce the viscosity of the excess build material in contact with the collection vat and allow for migration of the excess build material into a locale that provides for easier cleaning and/or easier recovery of the excess build material for later reuse. Likewise, a heated housing reservoir may accomplish the same.

### Rotating Drive Apparatus

In some embodiments, the rotating drive apparatus may be located beneath the spinning platform and beneath the collection vat.

In some embodiments, the rotating drive apparatus may be configured to spin one or more of the spinning platform and the collection vat. Spinning of the spinning platform and the collection vat may be independent of one another and/or the spinning of the spinning platform and the collection vat may be synchronous. For example, the rotating drive apparatus may spin both the spinning platform and the collection vat during the cleaning process, and later the collection vat may be independent spun, in either direction, to encourage the excess build material to migrate to a desired location. In other embodiments, more than one rotating drive apparatus may be included to independently spin the spinning platform and the collection vat.

### Light Source

In some embodiments, the post-processing device may include one or more light sources. For example, the post-processing device may include 1-10 light sources, e.g., 1, 2, 3, 4, 5, 6, 7, 8, 9, or 10, or a value within a range between any of the preceding values.

In some embodiments, at least one light source may be located above the spinning platform. In some embodiments, at least one light source may be located beneath a transparent spinning platform. Light sources may be located anywhere within the chamber, with or without the use of one or more mirror to direct the light to the workpieces; however, some locations may be more prone to collecting excess build material upon cleaning. In other embodiments, at least one light source may be located outside the chamber such that the light may pass into the chamber through a protective window.

In some embodiments, the light source may be characterized by a wavelength of about 250 nm to about 950 nm. For example, the light source may be characterized by a wavelength (in nm) of about 250, 275, 300, 325, 350, 375, 400, 425, 450, 475, 500, 525, 550, 575, 600, 625, 650, 675, 700, 725, 750, 775, 800, 825, 850, 875, 900, 925, or 950, or a value within a range between any of the preceding values, e.g., between about 350 nm and about 500 nm, or the like.

### Methods for Post-Processing a Workpiece

In various embodiments, a method for cleaning and post-curing a plurality of workpieces is described. The method may include providing a post-processing device described herein, spinning the plurality of workpieces on a spinning platform at a rate effective to remove at least a portion of excess build material from the plurality of workpieces, applying a vacuum to the chamber effective to reduce the pressure within the chamber, and applying a curing light to the plurality of workpieces while under vacuum for a period sufficient to cure the plurality of workpieces.

In many embodiments, each of the plurality of workpieces may be dental articles. In many embodiments, the plurality of workpieces may be selected from a dental crown, an implant, a bridge, a cap, a denture, an inlay, an onlay, a veneer, a facing, a coping, an abutment, a bracket, a buccal tube, a cleat, an attachment, a button, an aligner, a retainer, an indirect bonding tray, a direct bonding tray, or a combination thereof.

In many embodiments, the plurality of workpieces may be constructed from a build material characterized by a molecular weight of about 1,000 to 20,000 and a viscosity of at least about 6 Pa*s at 20 s⁻¹ at 23° C. (i.e., long-chain polymers). For example, the workpieces may be constructed from a build material characterized by a molecular weight of about 1000, 1500, 2000, 2500, 3000, 3500, 4000, 4500, 5000, 5500, 6000, 6500, 7000, 7500, 8000, 8500, 9000, 9500, 10000, 11000, 12000, 13000, 14000, 15000, 16000, 17000, 18000, 19000, or 20000, or a value within a range between any of the preceding values, e.g., between about 5000 and about 8000, or the like. For example, the build material may be characterized by a viscosity in Pa*s at 20 s⁻¹ at 23° C. of about 6, 7, 8, 9, 10, 11, 12, 13, 14, or 15, or a value within a range between any of the preceding values, e.g., between about 6 and about 9, or the like.

In many embodiments, the plurality of workpieces may be constructed from a build material selected from polyether (meth)acrylates, polyester (meth)acrylates, polycarbonate (meth)acrylates, and a combination thereof that are characterized as long-chain polymers described herein.

In some embodiments, the plurality of workpieces may be constructed from a build material that includes a polyether (meth)acrylate of formula (I):

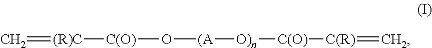

wherein:
each R is independently —H or —CH₃,
each A is independently a C₂₋₁₀ straight or branched alkylene; and
n is an integer from 100 to 10,000 (i.e., an integer selected to achieve a molecular weight of at least 1,000 and no more than 20,000).

In some embodiments, the plurality of workpieces may be constructed from a build material that includes a polyether (meth)acrylate of formula (I), wherein at least a portion of A is —CH₂CH₂— and at least a portion of A is —CH₂CH₂CH₂CH₂—.

In some embodiments, the plurality of workpieces may be constructed from a build material that includes a polyether (meth)acrylate of formula (I), wherein at least a portion of A is —CH₂CH₂— and at least a portion of A is —CH₂CH₂CH₂CH₂—; and wherein each R is —CH₃.

In some embodiments, the plurality of workpieces may be constructed from a build material that includes a polyether (meth)acrylate of formula (I), wherein at least a portion of A is —CH₂CH₂— and at least a portion of A is —CH₂CH₂CH₂CH₂—; wherein each R is —CH₃; and is characterized by a molecular weight of about 6,000.

In some embodiments, the plurality of workpieces may be constructed from a build material that is not compatible with solvents. Build materials that are not compatible with solvents are characterized as those that at least partially dissolve in the solvents or react with the build material. Example solvents include water, an organic solvent (e.g., alcohol (e.g., ethanol, isopropanol, or the like), esters (e.g., ethyl acetate, methyl butyrate, or the like), ethers (e.g., diethyl ether, methyl t-butyl ether, tetrahydrofuran, dioxane, or the like), ketones (e.g., acetone, methyl ethyl ketone, or the like), alkylhalides (e.g., chloroform, dichloromethane, or the like), alkanes (e.g., hexane, pentane, or the like), aromatics (e.g., benzene, toluene, or the like); or an aqueous solution comprising a dissolved or dispersed: salt (e.g., sodium chloride, calcium chloride, or the like), surfactant, (e.g., polysorbate, polyethylene glycol, or the like), acid (e.g., acetic acid, citric acid, or the like), base (e.g., sodium bicarbonate, sodium carbonate, borax, or the like), oxidant (e.g., hydrogen peroxide, sodium percarbonate, or the like), or a combination thereof.

In many embodiments, the method excludes any use of liquid (e.g., solvent) for cleaning the plurality of workpieces. In many embodiments, the method excludes any use of gas for cleaning the plurality or workpieces. The method may exclude use of both liquid and gas for cleaning.

In some embodiments, the spinning platform may be rotated at a rate of about 300 rpm to about 3000 rpm. For example, the suspended build carrier may be rotated at a rate, in rpm, of about 300, 400, 500, 600, 700, 800, 900, 1000, 1200, 1500, 1800, 2000, 2200, 2500, 2800, or 3000, or a value within a range between any of the preceding values, e.g., between about 500 rpm and about 1000 rpm, or the like. The rate at which the spinning platform is spun may be selected based on the type of build material of the workpieces. For example, some build materials may require higher rpm for effective removal of excess build material, whereas other build materials may deform at rpms that are too high.

In some embodiments the spinning platform may be rotated at a rate of a rate of about 300 rpm to about 3000 rpm for a period of about 1 min to about 30 min. For example, the spinning platform may be rotated for a period in minutes of about 1, 2, 3, 4, 5, 6, 7, 8, 9, 10, 12, 15, 18, 20, 22, 25, 28, or 30, or a value within a range between any of the preceding values, e.g., between about 5 and about 10, or the like.

In some embodiments, the spinning platform may be rotated clockwise or counterclockwise. In some embodiments, the spinning platform may be first rotated in one direction and later rotated in the opposite direction. In some embodiments, changing the direction of rotation may elicit a reorientation of the retention features upon the spinning platform such that the workpiece is also reoriented.

In some embodiments, the method may further include removing at least a portion of the excess build material from the collection vat. Removing the excess build material from the collection vat may include mechanically or manually wiping the collection vat. Removing excess build material from the collection vat may include removing a collection vat liner having the excess build material thereon. Removing excess build material from the collection vat may include spinning the collection vat and then mechanically or manually wiping the collection vat. In some embodiments, removing the excess build material may include spinning the collection vat and allowing the excess build material to migrate into a housing reservoir.

In some embodiments, the method may further include spinning the collection vat. The collection vat may be rotated at a rate of about 300 rpm to about 3000 rpm. For example, the suspended build carrier may be rotated at a rate, in rpm, of about 300, 400, 500, 600, 700, 800, 900, 1000, 1200, 1500, 1800, 2000, 2200, 2500, 2800, or 3000, or a value within a range between any of the preceding values, e.g., between about 500 rpm and about 1000 rpm, or the like. The rate at which the collection vat is spun may be selected based on the type of build material of the workpieces. In some embodiments, spinning the collection vat may occur concurrently with spinning the spinning platform, in the same or opposite direction as the spinning platform. In some embodiments, the spinning of the collection vat may occur post-spinning of the spinning platform or spinning of the collection vat may continue once spinning of the spinning platform ceases.

In some embodiments, the applying of light may be for a period of about 5 min to about 45 min. For examples, the applying of the light may be for a period in minutes of about 5, 10, 15, 20, 25, 30, 35, 40, or 45, or a value within a range between any of the preceding values, e.g., between about 15 and about 25, or the like. In some embodiments, the applying of light to the plurality of workpieces occurs while the chamber is under reduced pressure.

In various embodiments, a method for cleaning and post-curing a plurality of workpieces is described. The method may be independent of the post-processing devices described herein. The method may include spinning the plurality of workpieces on a spinning platform at a rate effective to remove at least a portion of excess build material from the plurality of workpieces; and applying a post-curing light to the plurality of workpieces while under vacuum for a period sufficient to cure the plurality of workpieces. The workpieces may include one or more long-chain polymer characterized by a molecular weight of 1,000-20,000 and a viscosity of at least 6 Pa*s at 20 s⁻¹ at 23° C. (e.g., a polymer of formula I described above, e.g., an α-ω methacrylated copolymer of ethyleneoxide/THF with a molecular weight of about 6,000).

### EQUIVALENTS

Those skilled in the art will recognize, or be able to ascertain, using no more than routine experimentation, numerous equivalents to the specific embodiments described specifically herein. Such equivalents are intended to be encompassed in the scope of the following claims.

1. A post-processing device comprising:
a chamber comprising:
an inlet configured to be in communication with a vacuum source, and
an electrical outlet configured to be in communication with a power source;
a spinning platform for retaining a plurality of workpieces,
a rotating drive apparatus for rotating the spinning platform;
a collection vat surrounding the spinning platform; and
one or more post-curing light source;
wherein the spinning platform, the rotating drive apparatus, and the collection vat, are housed within the chamber.

2.-6. (canceled)

7. The post-processing device of claim 1, the spinning platform comprising a retention wall, the retention wall comprising grated features.

8. The post-processing device of claim 7, the retention wall further comprising a plurality of partitioned units, each partitioned unit configured to retain a single workpiece.

9. The post-processing device of claim 8, wherein the plurality of partitioned units is situated in a circular arrangement.

10. The post-processing device of claim 8, wherein each of the plurality of partitioned units are radially adjustable in position along the spinning platform.

11. The post-processing device of claim 8, wherein one or IWM Of:
at least a portion of the plurality of partitioned units are grated, and
at least a portion of the spinning platform is grated.

12. (canceled)

13. The post-processing device of claim 1, further comprising a retention feature for securing each of the plurality of workpieces to the spinning platform.

14.-16. (canceled)

17. The post-processing device of claim 1, wherein the collection vat is in the shape of a half cylinder with an inward-slanting wall, wherein the inward-slanting wall is characterized by an angle (θ) of about 30° to about 85° with respect toa plane encompassed by a base portion of the collection vat.

18. (canceled)

19. The post-processing device of claim 1, the collection vat comprising a gutter within a base portion of the collection vat.

20. (canceled)

21. The post-processing device of claim 1, further comprising a holding reservoir beneath the collection vat,
wherein the collection vat comprises a base and a wall, and
wherein the collection vat is configured such that the base only connects to the wall in select locations,
wherein the holding reservoir and the collection vat are in communication via areas in which the base is not connected to the wall.

22.-24. (canceled)

25. The post-processing device of claim 1, wherein the rotating drive apparatus is configured to spin the spinning platform and the collection vat.

26.-30. (canceled)

31. The post-processing device of claim 1, further comprising one or more mirror.

32. The post-processing device of claim 1, further comprising a heating element selected from a non-curing light source, an induction heater, a convention heater, or a combination thereof.

33.-36. (canceled)

37. A method for cleaning and post-curing a plurality of workpieces, the method comprising:
providing a post-processing device of claim 1;
spinning the plurality of workpieces on a spinning platform at a rate effective to remove at least a portion of excess build material from the plurality of workpieces;
applying a vacuum to the chamber effective to reduce the pressure within the chamber;
applying curing light to the plurality of workpieces while under vacuum for a period sufficient to cure the plurality of workpieces.

38. The method of claim 37, wherein at least a portion of the plurality of workpieces are comprised of a build material characterized by a molecular weight of about 1,000 to 20,000 and a viscosity of at least about 6 Pa*s at 20 s⁻¹ at 23° C.

39.-43. (canceled)

44. The method of claim 37, one or more:
excluding any use of liquid for cleaning of the plurality of workpieces, and
excluding any use of gas for cleaning of the plurality of workpieces.

45. (canceled)

46. The method of claim 37, wherein the spinning of the spinning platform is at a rate from about 300 rpm to about 3,000 rpm.

47. (canceled)

48. The method of claim 37, further comprising spinning the collection vat.

49. The method of claim 37, further comprising spinning the collection vat and allowing the excess build resin to migrate from the collection vat and into a housing reservoir.

50. (canceled)

51. A method for cleaning and post-curing a plurality of workpieces, the method comprising:
spinning a plurality of workpieces on a spinning platform at a rate effective to remove at least a portion of excess build material from the plurality of workpieces;
applying curing light to the plurality of workpieces while under vacuum for a period sufficient to cure the plurality of workpieces,
wherein the plurality of workpieces comprise one or more long-chain polymer characterized by a molecular weight of 1,000-20,000 and a viscosity of at least 6 Pa*s at 20 s⁻¹ at 23° C.
